(19) United States
(12) Patent Application Publication
(10) Pub. No.: US 2023/0196241 A1
(43) Pub. Date: Jun. 22, 2023

(54) INFORMATION PROCESSING DEVICE, DISPLAY METHOD, AND COMPUTER PROGRAM PRODUCT

(71) Applicant: KABUSHIKI KAISHA TOSHIBA, Tokyo (JP)

(72) Inventor: Shinichi NAGANO, Yokohama (JP)

(73) Assignee: KABUSHIKI KAISHA TOSHIBA, Tokyo (JP)

(21) Appl. No.: 17/822,171

(22) Filed: Aug. 25, 2022

(30) Foreign Application Priority Data
Dec. 16, 2021 (JP) 2021-204622

(51) Int. Cl. G06Q 10/06

(52) U.S. Cl. CPC G06Q 10/0633

(57) ABSTRACT

According to an embodiment, an information processing device includes a memory and one or more processors coupled to the memory and configured to: generate, when a first synthesis operation of synthesizing one target data object among data objects that hold a status data group representing a status of a facility and one target visualization object among visualization objects that generate image data representing a data group is performed, on condition that an attribute of one or more parameters in the data group for which the target visualization object can generate the image data corresponds to an attribute of one or more parameters in the status data group held by the target data object, the image data representing the status data group held by the target data object in a display format defined in the target visualization object; and cause a display device to display the image data.

### CROSS-REFERENCE TO RELATED APPLICATIONS

This application is based upon and claims the benefit of priority from Japanese Patent Application No. 2021-204622, filed on Dec. 16, 2021; the entire contents of which are incorporated herein by reference.

### FIELD

Embodiments described herein relate generally to an information processing device, a display method, and a computer program product.

### BACKGROUND

For example, power plants, chemical plants, manufacturing plants, and infrastructure are equipped with many facilities. For example, the power plant includes a variety of facilities such as turbines, pumps, power generators, transformers, heaters, steam separators, and condensers. In order to operate such a plant normally, an information processing device receives status data representing the status of each facility from a sensor or the like installed in each facility, and causes a display device to display the received status data. A manager monitors the status data displayed on the display device and determines whether each facility is operating properly.

If an abnormal value is detected in the status data received from any of the facilities, the manager needs to presume the cause of the abnormality. In this case, the place with the abnormality is not necessarily in the facility where the abnormal value is detected, and may be in other related facilities.

Therefore, when an abnormal value is detected in the status data received from any of the facilities, the manager who checks the related facilities gets a piece of paper with a facility map showing the connection relationship and arrangement of the facilities and the like, and by comparing the facility map with the status data, presumes the facility where the abnormality occurs and the contents of the abnormality. If necessary, the manager also needs to graph and display the past data of the status data of the facility in which the abnormal value is detected and the status data of the related facility, or perform statistical calculations such as averaging on these pieces of status data.

However, it takes time and effort to presume the contents of the abnormality by comparing the paper with the facility map and the status data. In addition, determining what kind of graph needs to be created and what kind of statistical operation needs to be performed requires experiences. Therefore, inexperienced managers have to repeat the work of graphing the status data, performing the statistical calculations, and so on many times. Therefore, conventionally, such plants need to have experienced managers.

In recent years, there has been a shortage of personnel to manage facilities including such plants. Therefore, there is a demand for a management system that can properly support managers and reduce their workload in order to save manpower in the management of plants and the like.

It is an object of the present disclosure to provide an information processing device, a display method, and a computer program product to support management of a plurality of facilities by a manager.

### BRIEF DESCRIPTION OF THE DRAWINGS

FIG. 1 is a diagram illustrating a structure of a plant system according to an embodiment;

FIG. 2 is a diagram illustrating a functional structure of an information processing device;

FIG. 3 is a diagram illustrating an example of a display image;

FIG. 4 is a diagram illustrating an example of a status data group;

FIG. 5 is a diagram illustrating an example of a result data group;

FIG. 6 is a first flowchart expressing a procedure of a process in the information processing device;

FIG. 7 is a diagram illustrating a first example of the display image when the first flowchart is executed;

FIG. 8 is a diagram illustrating a second example of the display image when the first flowchart is executed;

FIG. 9 is a second flowchart expressing the procedure of the process in the information processing device;

FIG. 10 is a diagram illustrating the display image when the second flowchart is executed;

FIG. 11 is a third flowchart expressing the procedure of the process in the information processing device;

FIG. 12 is a diagram illustrating a first example of the display image when the third flowchart is executed;

FIG. 13 is a diagram illustrating a second example of the display image when the third flowchart is executed;

FIG. 14 is a diagram illustrating a functional structure of the information processing device according to a first modification;

FIG. 15 is a diagram illustrating a first example of the display image of the information processing device according to the first modification;

FIG. 16 is a diagram illustrating a second example of the display image of the information processing device according to the first modification;

FIG. 17 is a diagram illustrating a third example of the display image of the information processing device according to the first modification;

FIG. 18 is a diagram illustrating a functional structure of the information processing device according to a second modification;

FIG. 19 is a diagram illustrating a first example of the display image of the information processing device according to the second modification;

FIG. 20 is a diagram illustrating a second example of the display image of the information processing device according to the second modification; and

FIG. 21 is a diagram illustrating an example of a hardware structure of the information processing device.

### DETAILED DESCRIPTION

According to an embodiment, an information processing device includes a memory and one or more processors coupled to the memory. The one or more processors are configured to: generate, in a case where a first synthesis operation of synthesizing one target data object among a plurality of data objects that hold a status data group representing a status of a facility and one target visualization object among a plurality of visualization objects that generate image data representing a data group is performed, on condition that an attribute of one or more parameters in the data group for which the target visualization object is able to generate the image data corresponds to an attribute of one or more parameters in the status data group held by the target data object, the image data representing the status data group held by the target data object in a display format defined in the target visualization object; and cause a display device to display the image data.

A plant system 10 according to an embodiment is described below.

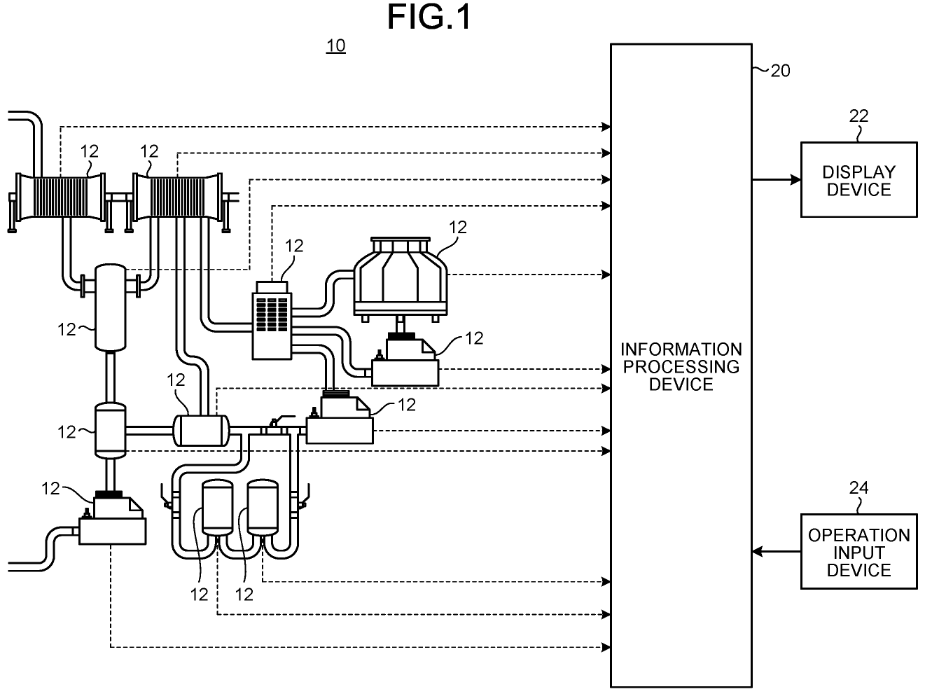

FIG. 1 is a diagram illustrating the plant system 10 according to the embodiment. Examples of the plant system 10 include power plants, chemical plants, and manufacturing plants. The plant system 10 may also be infrastructure such as roads, railroads, power grids, water grids, and communication networks.

The plant system 10 includes a plurality of facilities 12, an information processing device 20, a display device 22, and an operation input device 24.

Each of the facilities 12 is, for example, a component of a plant or infrastructure or equipment installed in a plant or infrastructure. If the plant system 10 is a power plant, each of the facilities 12 is, for example, a turbine, a pump, a power generator, a transformer, a heater, a steam separator, a condenser, or the like.

Each of the facilities 12 transmits the status data representing the status thereof to the information processing device 20. Each of the facilities 12, for example, transmits the status data to the information processing device 20 at regular intervals or when a predetermined event occurs.

The status data includes one or more parameters. Each of the one or more parameters is, for example, time, a value detected by a sensor in the corresponding facility 12, or a set value set in the corresponding facility 12. If the corresponding facility 12 is a pump, the status data includes, as an example, a parameter such as time, a vibration value detected by a vibration sensor, flow rate detected by a flow rate sensor, or consumption power detected by an electricity meter.

The information processing device 20 is a computer or the like that executes computer programs and performs calculation and control processes and the like according to the computer programs. The information processing device 20 also has a communication function and receives the status data from each of the facilities 12 periodically or when a predetermined event occurs. The information processing device 20 stores the received status data therein while correlating the status data with the corresponding facility 12.

The display device 22 displays information in response to control by the information processing device 20. The display device 22 can provide information to the manager of the plant system 10.

The operation input device 24 is a keyboard, a mouse, a touch panel, or the like. The operation input device 24, upon receiving the operation from the manager, supplies information representing the contents of the operation to the information processing device 20. The information processing device 20 executes information processing according to the operation by the manager.

The information processing device 20 stores therein the status data received from each of the facilities 12. The information processing device 20 receives the operation by the manager from the operation input device 24, applies the suitable display format and the appropriate calculation process to the stored status data, and causes the display device 22 to display the status data.

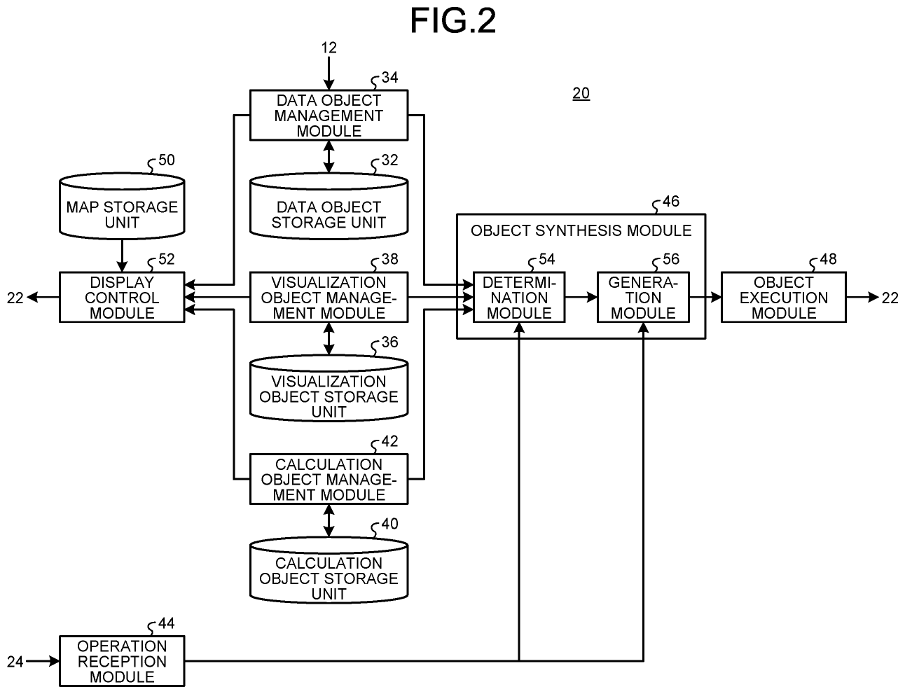

FIG. 2 is a diagram illustrating a functional structure of the information processing device 20.

The information processing device 20 has the functional structure as illustrated in FIG. 2 by executing a management computer program. In other words, the information processing device 20 includes a data object storage unit 32, a data object management module 34, a visualization object storage unit 36, a visualization object management module 38, a calculation object storage unit 40, a calculation object management module 42, an operation reception module 44, an object synthesis module 46, an object execution module 48, a map storage unit 50, and a display control module 52.

The data object storage unit 32 stores a plurality of data objects. The data object management module 34 manages the data objects stored in the data object storage unit 32. The data object management module 34 manages the data objects by, for example, registering, deleting, and changing each of the data objects stored in the data object storage unit 32 in response to the operation by the designer.

Each of the data objects is correlated with any of the facilities 12. Each of the data objects holds a status data group representing the status of the corresponding facility 12. The status data group contains a plurality of pieces of status data received from the corresponding facility 12. The status data group is an example of the data group. When the information processing device 20 has received the status data from any of the facilities 12, the data object management module 34 adds the received status data to the corresponding data object.

In each of the data objects, the attribute of one or more parameters of the status data included in the held status data group is determined in advance. Specifically, in each of the data objects, the number of one or more parameters and the data type of each of the one or more parameters are determined in advance as the attribute of the one or more parameters of the status data. For example, in each of the data objects, the name of each of one or more parameters may be determined in advance as the attribute of the one or more parameters of the status data.

The data type represents, for example, the format of the corresponding parameter. Examples of the data type include a date and time type, a real number type, a fixed point type, a floating point type, a Boolean type, and a text type. Alternatively, the data type may be a type that comprehensively expresses a plurality of data types. For example, the data type may be a numerical type that comprehensively expresses the real number type, the fixed point type, and the floating point type.

When a new facility 12 is added to the plant system 10, for example, the designer registers an empty data object corresponding to the new facility 12 in the data object storage unit 32. When any of the facilities 12 is removed from the plant system 10, for example, the designer deletes the data object corresponding to the removed facility 12 from the data object storage unit 32.

The visualization object storage unit 36 stores a plurality of visualization objects therein. The visualization object management module 38 manages the visualization objects stored in the visualization object storage unit 36. The designer, for example, creates the visualization objects and registers the created visualization objects in advance in the visualization object storage unit 36. The visualization object management module 38 manages the visualization objects by, for example, registering, deleting, and changing each of the visualization objects stored in the visualization object storage unit 36 in response to the operation from the designer.

To each of the visualization objects, the data group is input. Each of the visualization objects generates image data representing the input data group in a predefined display format. One example of the predefined display format is a time-series graph with time on the horizontal axis and values on the vertical axis. Other examples of the predefined display format include a bar graph, a histogram, a pie chart, and a two-dimensional graph. The predefined display format may alternatively be a table, for example.

In each of the visualization objects, the attribute of one or more parameters in the data group for which the image data can be generated is determined in advance. Specifically, in each of the visualization objects, the number of one or more parameters and the data type of each of the one or more parameters are determined in advance as the attribute of the one or more parameters of the data included in the data group for which the image data can be generated. In another example, in each of the visualization objects, the name of each of one or more parameters may be determined in advance as the attribute of the one or more parameters of the data included in the data group for which image data can be generated.

The calculation object storage unit 40 stores a plurality of calculation objects therein. The calculation object management module 42 manages the calculation objects stored in the calculation object storage unit 40. The designer, for example, creates the calculation objects and registers the created calculation objects in advance in the calculation object storage unit 40. The calculation object management module 42 manages the calculation objects by, for example, registering, deleting, and changing each of the calculation objects stored in the calculation object storage unit 40 in response to the operation from the designer.

To each of the calculation objects, the data group is input. For each of the calculation objects, a predefined calculation process is performed on the input data group to calculate a result data group. The result data group is an example of the data group.

The predefined calculation process may be a unary operation, for example, an operation to binarize any of the parameters of the pieces of data included in the input data group by a threshold set in advance. The predefined calculation process may be, for example, a statistical operation to calculate the mean, median, and maximum and minimum values for any one parameter of the pieces of data in the input data group. When any one parameter of the data in the input data group is a variable parameter representing a variable such as time or sequence, and another parameter is a value parameter representing a numerical value or the like, the predefined calculation process may be a filtering process such as a differentiating process, an integrating process, or a moving averaging process.

To each of the calculation objects, two or more data groups may be input. In this case, the predefined calculation process may be an operation of adding, subtracting, dividing, or multiplying any of the parameters between the corresponding pieces of data in two or more data groups. For example, in this case, the predefined calculation process may be an operation of adding, subtracting, dividing, or multiplying two or more value parameters in the data with the same variable parameters.

In each of the calculation objects, the attribute of one or more parameters in the data group that can be calculated is determined in advance. Specifically, in each of the calculation objects, the number of one or more parameters and the data type of each of the one or more parameters are determined in advance as the attribute of the one or more parameters of the data included in the data group that can be calculated. For example, in each of the calculation objects, the name of each of one or more parameters may be determined in advance as the attribute of the one or more parameters of the data included in the data group that can be calculated.

In each of the calculation objects, the attribute of one or more parameters in the result data group obtained by performing the predefined calculation process is determined in advance. Specifically, in each of the calculation objects, the number of one or more parameters and the data type of each of the one or more parameters are determined in advance as the attribute of the one or more parameters of the data included in the result data group that can be obtained by performing the predefined calculation process. For example, in each of the calculation objects, the name of each of one or more parameters may be determined in advance as the attribute of the one or more parameters of the data included in the result data group that can be obtained by performing the predefined calculation process.

The operation reception module 44 receives a synthesis operation from, for example, the manager through the operation input device 24. The operation reception module 44 receives, for example, a data-visualization synthesis operation of synthesizing any one target data object among the data objects with any one target visualization object among the visualization objects. The operation reception module 44 may also receive, for example, a data-calculation synthesis operation of synthesizing any one target data object among the data objects with any one target calculation object among the calculation objects. The operation reception module 44 may also receive, for example, a data-calculation-visualization synthesis operation of synthesizing any one target data object among the data objects, any one target calculation object among the calculation objects, and any one target visualization object among the visualization objects.

When the synthesis operation is performed, the object synthesis module 46 determines whether the object for which the synthesis operation has been performed can be synthesized, and if it is determined that the synthesis is possible, generates a synthesis object. More specifically, the object synthesis module 46 includes a determination module 54 and a generation module 56.

When the data-visualization synthesis operation is performed, the determination module 54 determines whether the attribute of one or more parameters in the data group for which the target visualization object can generate image data corresponds to the attribute of one or more parameters in the status data group held by the target data object.

When the data-calculation synthesis operation is performed, the determination module 54 determines whether the attribute of one or more parameters in the data group that can be calculated by the target calculation object corresponds to the attribute of one or more parameters in the status data group held by the target data object.

When the data-calculation-visualization synthesis operation is received, the determination module 54 determines that the attribute of one or more parameters in the data group that can be calculated by the target calculation object corresponds to the attribute of one or more parameters in the status data group held by the target data object. When the data-calculation-visualization synthesis operation is received, the determination module 54 determines whether the attribute of one or more parameters in the data group for which the target visualization object can generate image data corresponds to the attribute of one or more parameters in the result data group obtained by performing the calculation process of the target calculation object.

When the synthesis operation is performed, the generation module 56 generates a synthesis object on condition that the determination module 54 determines that the synthesis is possible.

For example, when the data-visualization synthesis operation is performed, the generation module 56 generates a first synthesis object on condition that the target data object and the target visualization object are determined to be synthesizable. The first synthesis object holds the status data group held by the target data object, generates image data representing the status data group in the display format defined in the target visualization object, and causes the display device 22 to display the image data.

For example, when the data-calculation synthesis operation is received, the generation module 56 generates a second synthesis object on condition that the determination module 54 determines the target data object and the target calculation object are synthesizable. The second synthesis object holds the status data group held by the target data object, performs the calculation process defined in the target calculation object on the status data group to calculate the result data group, and causes the display device 22 to display the calculated result data group.

For example, when the data-calculation-visualization synthesis operation is performed, the generation module 56 generates a third synthesis object on condition that the determination module 54 determines the target data object, the target calculation object, and the target visualization object are synthesizable. The third synthesis object holds the status data group held by the target data object, performs the calculation process defined in the target calculation object on the status data group to calculate the result data group, generates image data representing the result data group in the display format defined in the target visualization object, and causes the display device 22 to display the image data.

The object execution module 48 executes the synthesis object when the object synthesis module 46 generates the synthesis object. For example, when the first object is executed, the object execution module 48 generates image data representing the status data group held by the target data object in the display format defined in the target visualization object and causes the display device 22 to display the image data.

For example, when the second synthesis object is generated, the object execution module 48 performs the calculation process defined in the target calculation object on the status data group held by the target data object to calculate the result data group, and causes the display device 22 to display the calculated result data group.

For example, when the third synthesis object is executed, the object execution module 48 performs the calculation process defined in the target calculation object on the status data group held by the target data object to calculate the result data group, generates image data representing the result data group in the display format defined in the target visualization object, and causes the display device 22 to display the image data.

The map storage unit 50 stores therein map information representing the arrangement and connection relation of the facilities 12. The display control module 52 generates an image to receive the synthesis operation from the manager and causes the display device 22 to display the image.

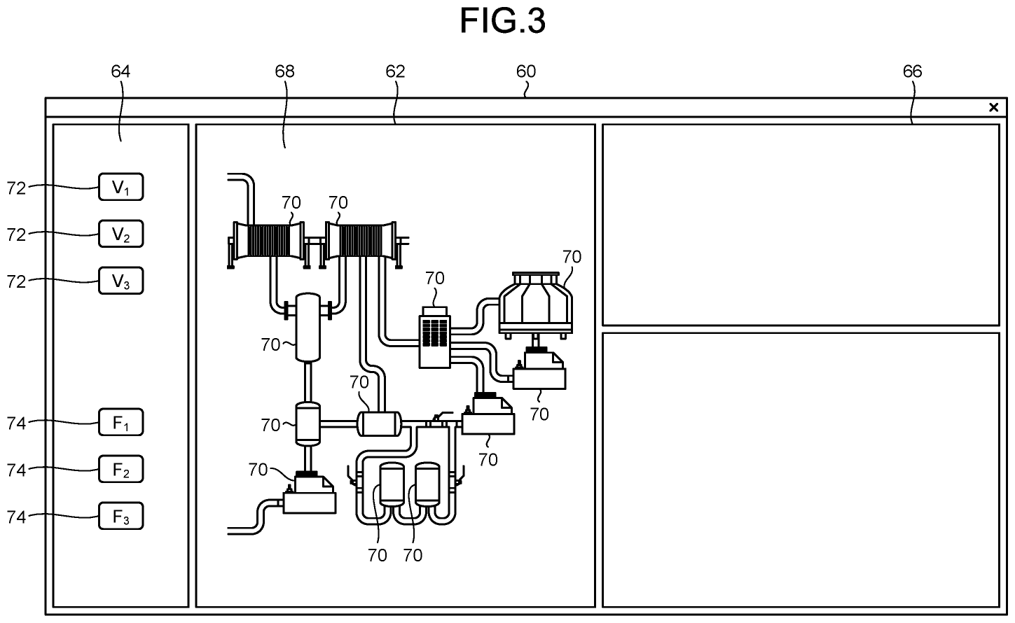

FIG. 3 is a diagram illustrating an example of a display image 60. The display control module 52 generates the display image 60 as illustrated in FIG. 3 as the image to receive the synthesis operation from the manager, and causes the display device 22 to display the image.

The display image 60 includes a map region 62, an object region 64, and a result region 66.

The display control module 52 displays a map image 68 in the map region 62. The map image 68 is an example of the map information and represents the arrangement and connection relation of the facilities 12. For example, if the plant system 10 is a power plant, the map image 68 is image data representing, for example, pipes connecting turbines, pumps, power generators, transformers, heaters, steam separators, or condensers, and electrical wires connecting these. The display control module 52 reads out the map image 68 from the map storage unit 50 and displays the map image 68 in the map region 62.

The display control module 52 also displays each of a plurality of data object icons 70 at the position of the corresponding facility 12 among the facilities 12 on the map image 68. Each of the data object icons 70 corresponds to any of the data objects. That is, each of the data object icons 70 corresponds to any of the facilities 12.

Each of the data object icons 70 is an image representing the corresponding facility 12. Thus, the manager can recognize which facility 12 each of the data object icons 70 displayed on the map image 68 is correlated with. Along with this, the manager can recognize how the facilities 12 are connected by seeing the map image 68 and the data object icons 70.

The display control module 52 displays a plurality of visualization object icons (V₁, V₂, V₃) 72 in the object region 64. Each of the visualization object icons 72 corresponds to any of the visualization objects. Each of the visualization object icons 72 is an image representing the corresponding visualization object. By using the operation input device 24, the manager can select any of the visualization object icons 72 and drag and drop the visualization object icon 72 to an arbitrary position on the display image 60.

The display control module 52 also displays a plurality of calculation object icons (F₁, F₂, F₃) 74 in the object region 64. Each of the calculation object icons 74 is correlated with any of the calculation objects. Each of the calculation object icons 74 is an image representing the corresponding calculation object. By using the operation input device 24, the manager can select any of the calculation object icons 74 and drag and drop the calculation object icon 74 to any position on the display image 60.

The display control module 52 displays the result of executing the synthesis object in the result region 66.

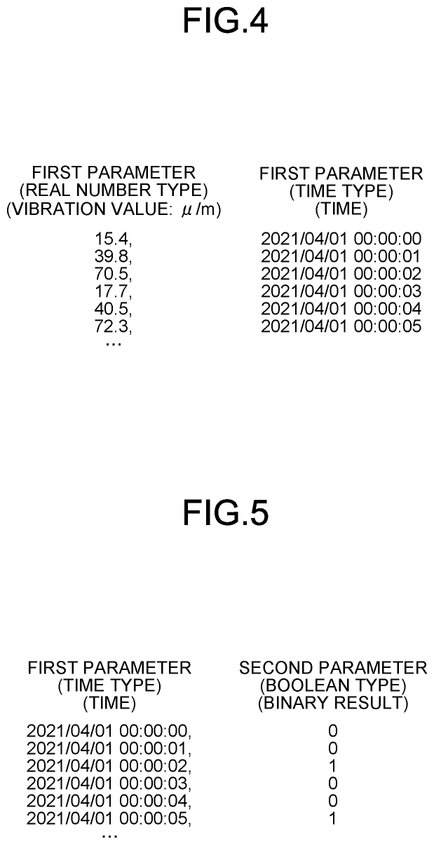

FIG. 4 is a diagram illustrating an example of the status data group.

Each of the data objects holds the status data group. The status data group includes a plurality of pieces of status data. Each piece of the status data includes one or more parameters. Each of the one or more parameters in the status data has a name determined in advance. The name may be, for example, text set by the manufacturer who manufactured the corresponding facility 12, or may be text set by the designer of the plant system 10. Each of the one or more parameters in the status data has a data type determined in advance.

The status data group illustrated in FIG. 4 is acquired, for example, from a pump. The status data included in the status data illustrated in FIG. 4 includes two parameters: a first parameter and a second parameter. The first parameter in FIG. 4 has a name of vibration value and a data type of real number type. The second parameter in FIG. 4 has a name of time and a data type of time type.

FIG. 5 is a diagram illustrating an example of the result data group.

Each of the calculation objects outputs the result data group. The result data group includes a plurality of pieces of result data. Each piece of the result data includes one or more parameters. Each of the one or more parameters in the result data has a name determined in advance. The name is, for example, the text set by the designer of the plant system 10. Each of the one or more parameters in the result data has a data type determined in advance.

The result data group illustrated in FIG. 5 is output from the calculation object in which the real number values in the input data group are binarized with a predetermined threshold. The result data included in the result data group illustrated in FIG. 5 includes two parameters: the first parameter and the second parameter. The first parameter in FIG. 5 has a name of time and a data type of time type. The second parameter in FIG. 5 has a name of binary result and a data type of Boolean type.

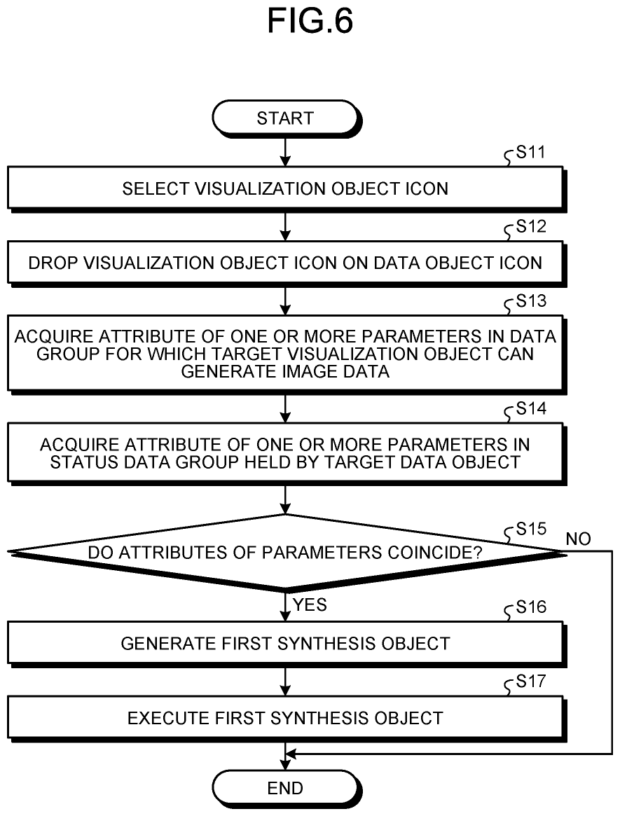

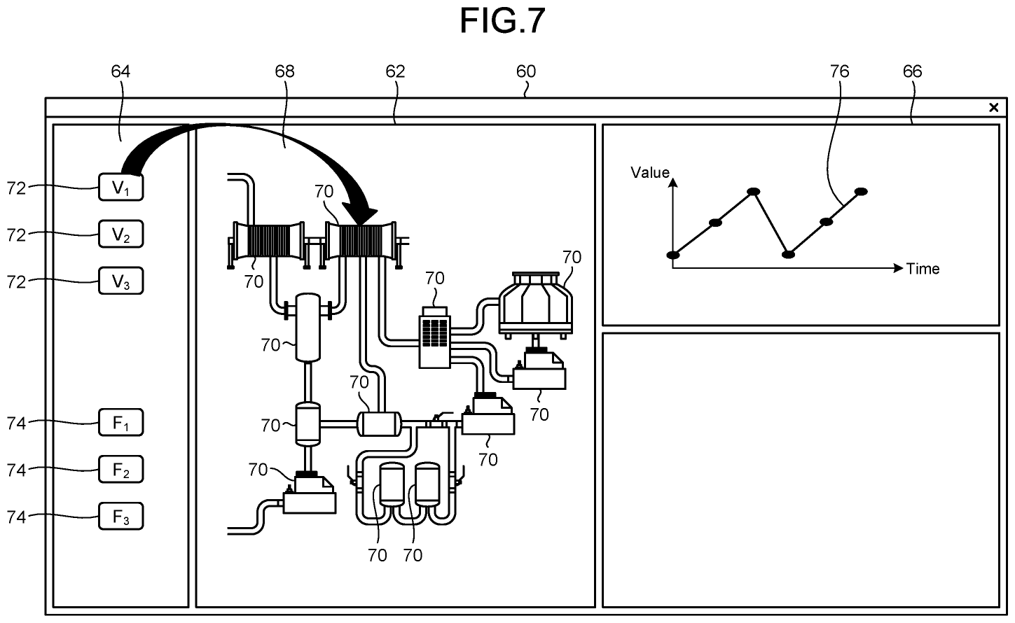

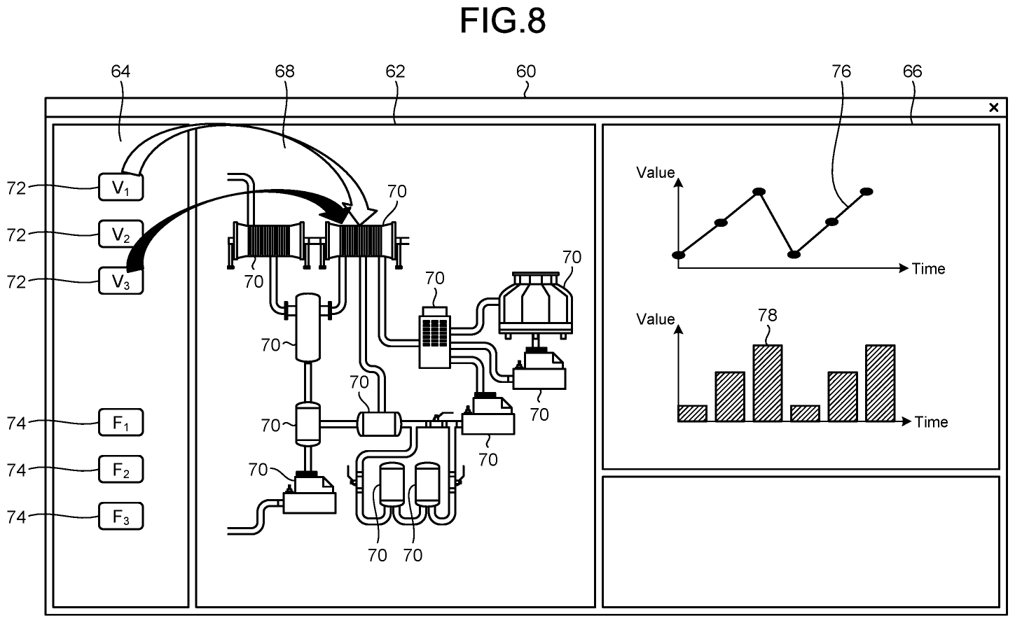

FIG. 6 is a first flowchart expressing the procedure of the process in the information processing device 20. FIG. 7 is a diagram illustrating a first example of the display image 60 when the first flowchart is executed. FIG. 8 is a diagram illustrating a second example of the display image 60 when the first flowchart is executed.

The information processing device 20 may perform the process in accordance with the first flowchart illustrated in FIG. 6, for example.

First, at S11, the information processing device 20 receives, from the manager, an operation of selecting any one of the visualization object icons 72.

Subsequently, at S12, as illustrated in FIG. 7, the information processing device 20 receives, from the manager, an operation of dragging the selected visualization object icon 72 on the display image 60 and dropping the visualization object icon 72 on any of the data object icons 70. This allows the information processing device 20 to receive, from the manager, an operation of correlating any one of the data object icons 70 with any one of the visualization object icons 72. When such an operation is performed, the information processing device 20 receives the data-visualization synthesis operation with the data object corresponding to the data object icon 70 at the drop destination set as the target data object, and the visualization object corresponding to the selected visualization object icon 72 set as the target visualization object.

Then, at S13, the information processing device 20 acquires the attribute of one or more parameters in the data group for which the target visualization object can generate image data. Specifically, the information processing device 20 refers to the visualization object storage unit 36 to obtain the number of one or more parameters and the data type of each of the one or more parameters of the data included in the data group for which the target visualization object can generate the image data.

Then, at S14, the information processing device 20 acquires the attribute of one or more parameters in the status data group held by the target data object. Specifically, the information processing device 20 refers to the data object storage unit 32 to acquire the number of one or more parameters and the data type of each of the one or more parameters of the status data included in the status data group held by the target data object.

Then, at S15, the information processing device 20 determines whether the attribute of one or more parameters in the data group for which the target visualization object can generate image data corresponds to the attribute of one or more parameters in the status data group held by the target data object. For example, the information processing device 20 determines whether the number of one or more parameters and the data type of each of the one or more parameters of the data included in the data group for which the target visualization object can generate image data correspond to the number of one or more parameters and the data type of each of the one or more parameters of the status data included in the status data group held by the target data object.

More specifically, for example, the information processing device 20 performs a first determination process to determine whether the number of one or more parameters of the data included in the data group for which the target visualization object can generate image data corresponds to the number of one or more parameters of the status data included in the status data group held by the target data object. Furthermore, the information processing device 20 correlates on the one-to-one basis the one or more parameters of the data included in the data group for which the target visualization object can generate image data, and the one or more parameters of the status data included in the status data group held by the target data object. Then, the information processing device 20 performs a second determination process to determine whether all the data types correspond to each other among the correlated parameters. When both the first and the second determination processes result in the coincidence, the information processing device 20 determines that the attribute of one or more parameters in the data group for which the target visualization object can generate image data corresponds to the attribute of one or more parameters in the status data group held by the target data object.

If the attributes do not coincide (No at S15), the information processing device 20 terminates this procedure because synthesis is impossible. In this case, the information processing device 20 may display an error message or the like to the manager. If the attributes coincide (Yes at S15), the information processing device 20 advances the process to S16 because the synthesis is possible.

At S16, the information processing device 20 generates the first synthesis object on condition that the target data object and the target visualization object are determined to be synthesizable.

Then, at S17, the information processing device 20 executes the first synthesis object in response to the generation of the first synthesis object. In other words, the information processing device 20 holds the status data group held by the target data object, generates image data representing the status data group in the display format defined in the target visualization object, and causes the display device 22 to display the image data.

For example, the information processing device 20 displays the result of executing the first synthesis object in the result region 66 as illustrated in FIG. 7. This allows the information processing device 20 to display a first result image 76, which represents a line graph with time on the horizontal axis and values on the vertical axis, as illustrated in FIG. 7. The information processing device 20 terminates this procedure after completing S17.

By executing the above process, the information processing device 20 can display the status data group representing the status of the facility 12 in the selected display format with a simple operation without requiring programming, etc.

The information processing device 20 may further perform the process in accordance with the first flowchart in FIG. 6 from the state in which the first result image 76 is displayed. In this case, as illustrated in FIG. 8, the information processing device 20 can display image data in a different display format if the manager selects the visualization object icon 72 that is different from the visualization object icon 72 selected the first time. For example, as illustrated in FIG. 8, the information processing device 20 can display a second result image 78 representing a bar graph with time on the horizontal axis and values on the vertical axis. This allows the information processing device 20 to display the status data group representing the status of the facility 12 in a plurality of display formats with the simple operation without requiring programming, etc.

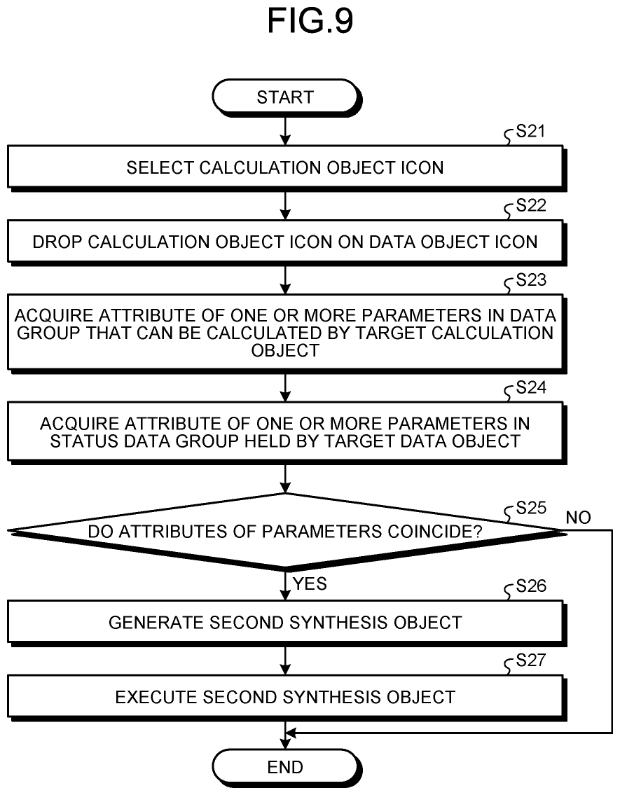

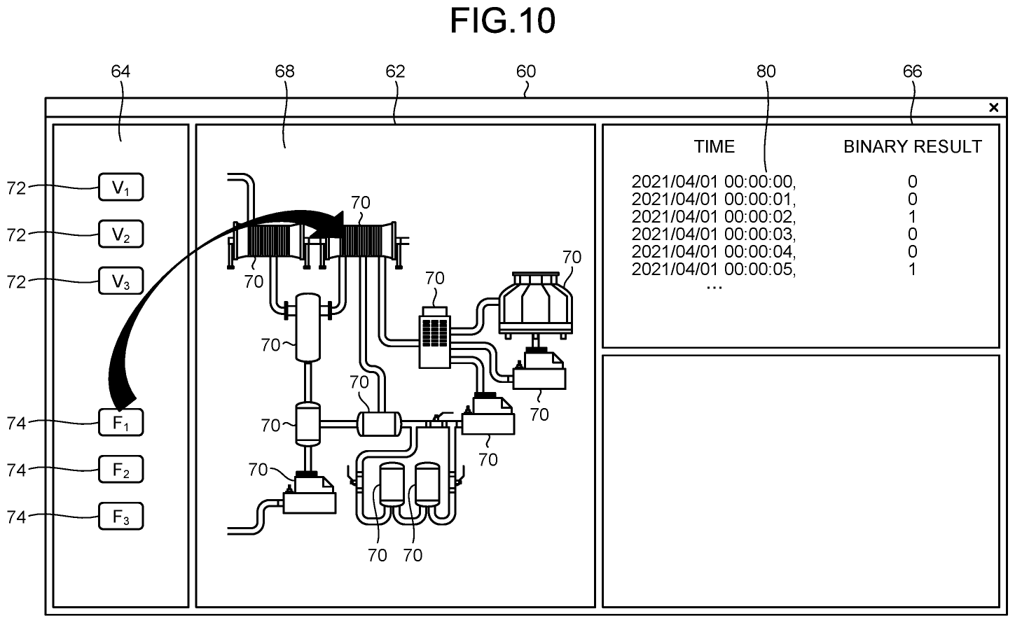

FIG. 9 is a second flowchart expressing the procedure of the process in the information processing device 20. FIG. 10 is a diagram illustrating a first example of the display image 60 when the second flowchart is executed.

The information processing device 20 may, for example, perform the process in accordance with the second flowchart in FIG. 9.

First, at S21, the information processing device 20 receives, from the manager, an operation of selecting any one of the calculation object icons 74.

Then, at S22, the information processing device 20 receives, from the manager, an operation of dragging the selected calculation object icon 74 and dropping the calculation object icon 74 on any of the data object icons 70 as illustrated in FIG. 10. This allows the information processing device 20 to receive, from the manager, an operation of correlating any one of the data object icons 70 with any one of the calculation object icons 74. When such an operation is performed, the information processing device 20 receives the data-calculation synthesis operation with the data object corresponding to the data object icon 70 at the drop destination set as the target data object and the calculation object corresponding to the selected calculation object icon 74 set as the target calculation object.

Then, at S23, the information processing device 20 acquires the attribute of one or more parameters in the data group that can be calculated by the target calculation object. Specifically, the information processing device 20 refers to the calculation object storage unit 40 to acquire the number of one or more parameters and the data type of each of the one or more parameters of the data included in the data group that can be calculated by the target calculation object.

Then, at S24, the information processing device 20 acquires the attribute of one or more parameters in the status data group held by the target data object. Specifically, the information processing device 20 refers to the data object storage unit 32 to acquire the number of one or more parameters and the data type of each of the one or more parameters of the status data included in the status data group held by the target data object.

Then, at S25, the information processing device 20 determines whether the attribute of one or more parameters in the data group that can be calculated by the target calculation object corresponds to the attribute of one or more parameters in the status data group held by the target data object. For example, the information processing device 20 determines whether the number of one or more parameters and the data type of each of the one or more parameters of the data included in the data group that can be calculated by the target calculation object correspond to the number of one or more parameters and the data type of each of the one or more parameters of the status data included in the status data group held by the target data object.

More specifically, for example, the information processing device 20 performs the first determination process to determine whether the number of one or more parameters of the data included in the data group that can be calculated by the target calculation object corresponds to the number of one or more parameters of the status data included in the status data group held by the target data object. Furthermore, the information processing device 20 correlates on the one-to-one basis one or more parameters of the data included in the data group that can be calculated by the target calculation object with one or more parameters of the status data included in the status data group held by the target data object. Then, the information processing device 20 performs the second determination process to determine whether all the data types correspond to each other among the correlated parameters. When both the first and second determination processes result in the coincidence, the information processing device 20 determines that the attribute of one or more parameters in the data group that can be calculated by the target calculation object corresponds to the attribute of one or more parameters in the status data group held by the target data object.

If the attributes do not coincide (No at S25), the information processing device 20 terminates this procedure because synthesis is impossible. In this case, the information processing device 20 may display an error message or the like to the manager. If the attributes coincide (Yes at S25), the information processing device 20 advances the process to S26 because the synthesis is possible.

At S26, the information processing device 20 generates the second synthesis object on condition that the target data object and the target calculation object are determined to be synthesizable.

Then, at S27, the information processing device 20 executes the second synthesis object in response to the generation of the second synthesis object. In other words, the information processing device 20 holds the status data group held by the target data object, performs the calculation process defined in the target calculation object on the status data group to calculate the result data group, and causes the display device 22 to display the calculated result data group.

For example, the information processing device 20 displays the result of executing the second synthesis object in the result region 66 as illustrated in FIG. 10. This allows the information processing device 20 to display a third result image 80 in which the result data group is arranged in a row as illustrated in FIG. 10. The information processing device 20 terminates this procedure after completing S27.

By executing the above process, the information processing device 20 can display the image data representing the result of performing the predetermined calculation on the status data group representing the status of the facility 12 with a simple operation without requiring programming, etc.

The information processing device 20 may further perform the process in accordance with the first flowchart in FIG. 6 from the state in which the third result image 80 is displayed. In this case, the information processing device 20 can display the result of the different calculation process if the manager selects the calculation object icon 74 that is different from the calculation object icon 74 selected the first time. This allows the information processing device 20 to display the results of the calculation processes with respect to the status data group representing the status of the facility 12 with the simple operation without requiring programming, etc.

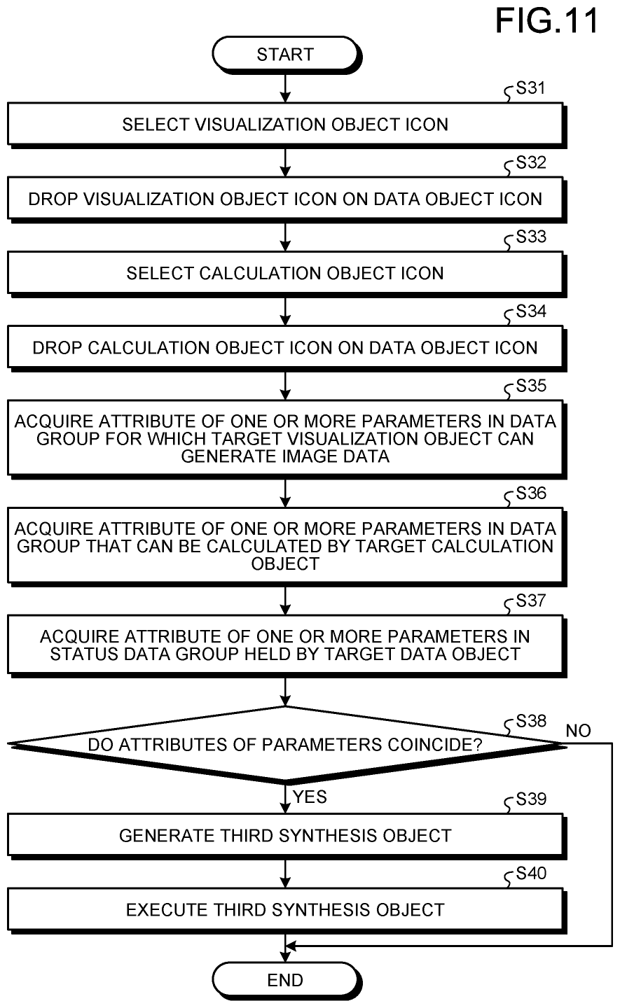

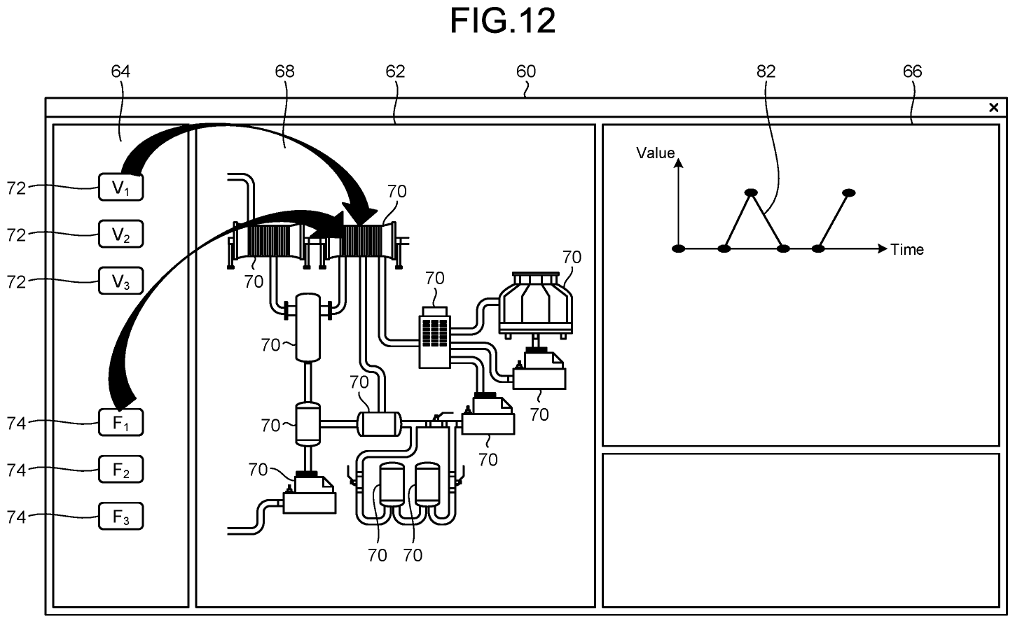

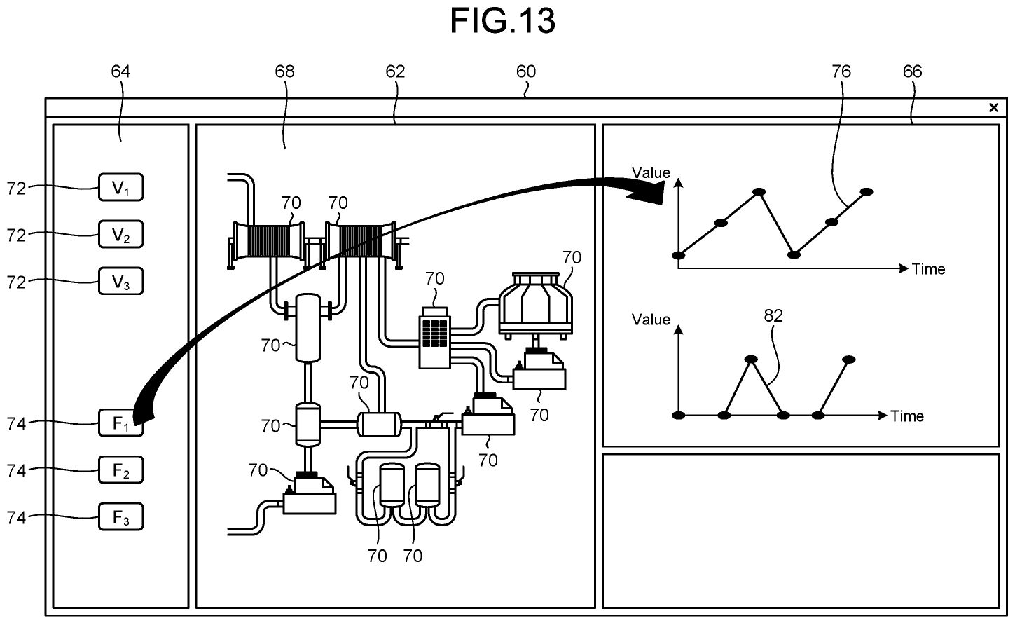

FIG. 11 is a third flowchart expressing the procedure of the process in the information processing device 20. FIG. 12 is a diagram illustrating a first example of the display image 60 when the third flowchart is executed. FIG. 13 is a diagram illustrating a second example of the display image 60 when the third flowchart is executed.

The information processing device 20 may perform the process in accordance with the third flowchart in FIG. 11, for example.

First, at S31, the information processing device 20 receives, from the manager, an operation of selecting any one of the visualization object icons 72.

Subsequently, at S32, as illustrated in FIG. 12, the information processing device 20 receives, from the manager, an operation of dragging the selected visualization object icon 72 on the display image 60 and dropping the visualization object icon 72 on any of the data object icons 70. This allows the information processing device 20 to receive, from the manager, an operation of correlating any one of the data object icons 70 with any one of the visualization object icons 72.

Subsequently, at S33, the information processing device 20 receives, from the manager, an operation of selecting any one of the calculation object icons 74.

Then, at S34, as illustrated in FIG. 12, the information processing device 20 receives, from the manager, an operation of dragging the selected calculation object icon 74 and dropping the calculation object icon 74 on one of the data object icons 70 on which the visualization object icon 72 has been dropped at S32. This allows the information processing device 20 to receive, from the manager, an operation of correlating any of the data object icons 70, any of the visualization object icons 72, and any of the calculation object icons 74.

When a series of operations from S31 to S34 is performed, the information processing device 20 receives the data-calculation-visualization synthesis operation of the target data object, the target calculation object, and the target visualization object while the data object corresponding to the data object icon 70 at the drop destination is set as the target data object, the visualization object corresponding to the selected visualization object icon 72 is set as the target visualization object, and the calculation object corresponding to the selected calculation object icon 74 is set as the target calculation object.

Then, at S35, the information processing device 20 acquires the attribute of one or more parameters in the data group for which the target visualization object can generate image data.

Then, at S36, the information processing device 20 acquires the attribute of one or more parameters in the data group that can be calculated by the target calculation object.

Then, at S37, the information processing device 20 acquires the attribute of one or more parameters in the status data group held by the target data object.

Subsequently, at S38, the information processing device 20 determines whether the attribute of one or more parameters in the data group that can be calculated by the target calculation object corresponds to the attribute of one or more parameters in the status data group held by the target data object. In addition to this, the information processing device 20 determines whether the attribute of one or more parameters in the data group for which the target visualization object can generate image data corresponds to the attribute of one or more parameters in the result data group obtained by performing the calculation process of the target calculation object.

For example, the information processing device 20 determines whether the number of one or more parameters and the data type of each of the one or more parameters of the data included in the data group that can be calculated by the target calculation object correspond to the number of one or more parameters and the data type of each of the one or more parameters of the status data included in the status data group held by the target data object. In addition to this, the information processing device 20 determines whether the number of one or more parameters and the data type of each of the one or more parameters of the data included in the data group for which the target visualization object can generate image data correspond to the number of one or more parameters and the data type of each of the one or more parameters of the data included in the result data group obtained by performing the calculation process of the target calculation object.

More specifically, the information processing device 20 performs the first determination process to determine whether the number of one or more parameters of the data included in the data group that can be calculated by the target calculation object corresponds to the number of one or more parameters of the status data included in the status data group held by the target data object. Furthermore, the information processing device 20 correlates on the one-to-one basis one or more parameters of the data included in the data group that can be calculated by the target calculation object with one or more parameters of the status data included in the status data group held by the target data object. The information processing device 20 then performs the second determination process to determine whether all the data types correspond to each other among the correlated parameters. When both the first and second determination processes result in the coincidence, the information processing device 20 determines that the attribute of one or more parameters in the data group that can be calculated by the target calculation object corresponds to the attribute of one or more parameters in the status data group held by the target data object.

In addition to this, the information processing device 20 performs a third determination process to determine whether the number of one or more parameters of the data included in the data group for which the target visualization object can generate image data corresponds to the number of one or more parameters of the result data included in the result data group obtained by performing the calculation process of the target calculation object. In addition, the information processing device 20 correlates on the one-to-one basis one or more parameters of the data included in the data group for which the target visualization object can generate image data with one or more parameters of the result data included in the result data group obtained by performing the calculation process of the target calculation object. Then, the information processing device 20 performs a fourth determination process to determine whether all the data types correspond to each other among the correlated parameters. When both the third and fourth determination processes result in the coincidence, the information processing device 20 determines that the attribute of one or more parameters in the data group for which the target visualization object can generate image data corresponds to the attribute of one or more parameters in the result data group obtained by performing the calculation process of the target calculation object.

If the attributes do not coincide (No at S38), the information processing device 20 terminates this procedure because synthesis is impossible. In this case, the information processing device 20 may display an error message or the like to the manager. If the attributes coincide (Yes at S38), the information processing device 20 advances the process to S39 because the synthesis is possible.

At S39, the information processing device 20 generates the third synthesis object on condition that the target data object, the target calculation object, and the target visualization object are determined to be synthesizable.

Then, at S40, the information processing device 20 executes the third synthesis object in response to the generation of the third synthesis object. In other words, the information processing device 20 holds the status data group held by the target data object, performs the calculation process defined in the target calculation object on the status data group to calculate the result data group, generates image data representing the result data group in the display format defined in the target visualization object, and causes the display device 22 to display the image data.

For example, the information processing device 20 displays the result of executing the third synthesis object in the result region 66 as illustrated in FIG. 12. This allows the information processing device 20 to display a fourth result image 82, which represents a line graph with time on the horizontal axis and binary values on the vertical axis, as illustrated in FIG. 12. The information processing device 20 terminates this procedure after completing S40.

By executing the above process, the information processing device 20 can perform the predetermined calculation on the status data group representing the status of the facility 12 and display the result data group resulting from the predetermined calculation as the image data in the predetermined display format with the simple operation without requiring programming, etc.

The processes of S31 and S32 are similar to those of S11 and S12 in FIG. 6. Therefore, at the stage of executing S31 and S32, the information processing device 20 may perform the process in the first flowchart in FIG. 6 to display the first result image 76 illustrated in FIG. 7. If the processes of S33 and S34 are performed with the first result image 76 in FIG. 7 displayed, the information processing device 20 may perform the process of S35 and the subsequent processes. In this case, the information processing device 20 displays the fourth result image 82 below the first result image 76 in the result region 66 of the display image 60, for example.

As illustrated in FIG. 13, the information processing device 20 may perform the process of S35 and the subsequent processes when the calculation object icon 74 is dragged and dropped onto the first result image 76 while the first result image 76 is displayed. In this case, the information processing device 20 also displays the fourth result image 82 below the first result image 76 in the result region 66 of the display image 60, for example.

The information processing device 20 may also perform the process of S35 and the subsequent processes when the operations in S33 and S34 are performed first and the operations in S31 and S32 are performed later. In other words, also in the case where the calculation object icon 74 is dragged and dropped onto the data object icon 70 and then the visualization object icon 72 is dragged and dropped onto the same data object icon 70, the information processing device 20 may perform the process of S35 and the subsequent processes to display the fourth result image 82.

In the case where the operations of S33 and S34 are performed first and the operations of S31 and S32 are performed later, the information processing device 20 may perform the process in the second flowchart in FIG. 9 at the stage where S33 and S34 are performed, so that the third result image 80 illustrated in FIG. 10 is displayed. The information processing device 20 may perform the process of S35 and the subsequent processes when the processes of S31 and S32 are performed with the third result image 80 in FIG. 10 displayed. In this case, the information processing device 20 displays the fourth result image 82 below the third result image 80 in the result region 66 of the display image 60, for example.

The information processing device 20 may also perform the process of S35 and the subsequent processes when the calculation object icon 74 is dragged and dropped onto the third result image 80 in FIG. 10 with the third result image 80 displayed. In this case, the information processing device 20 also displays the fourth result image 82 below the third result image 80 in the result region 66 of the display image 60.

As described above, the information processing device 20 according to this embodiment displays the status data group representing the status of the facility 12 in the selected display format with the simple operation. The information processing device 20 according to this embodiment displays the image data representing the result of performing the predetermined calculation on the status data group representing the status of the facility 12 with the simple operation. For example, the information processing device 20 performs the predetermined calculation on the status data group representing the status of the facility 12, and displays the result data group resulting from the predetermined calculation as the image data in the predetermined display format with the simple operation. Thus, the burden on the manager can be reduced by the information processing device 20 according to this embodiment. Therefore, by the information processing device 20 according to this embodiment, the plant system 10 can be managed by less experienced managers, and the management requires fewer people.

First Modification

Next, the information processing device 20 according to a first modification is described.

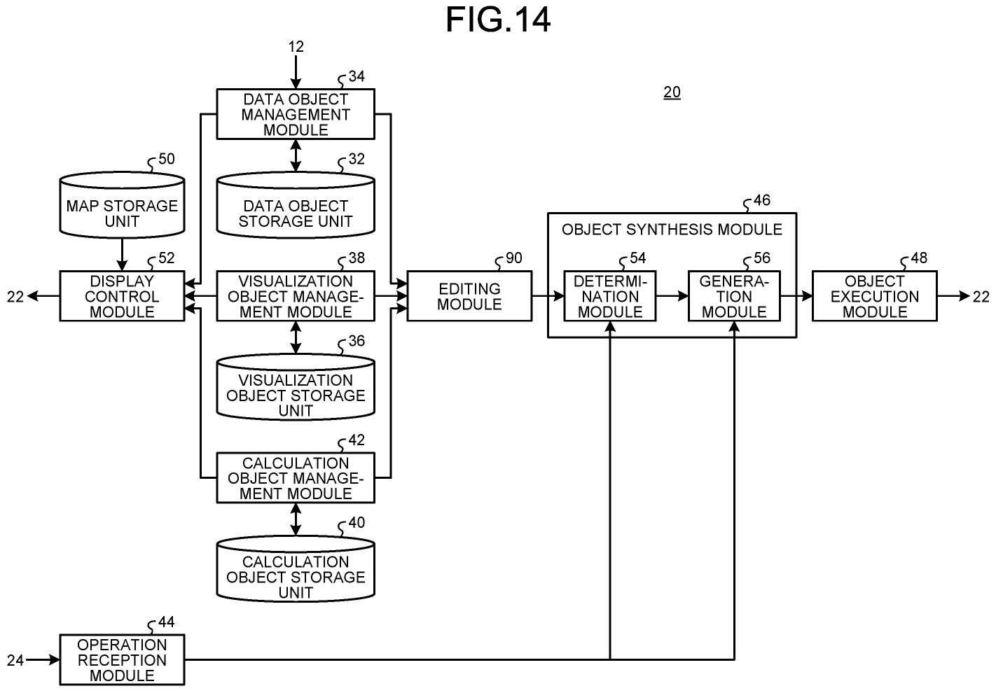

FIG. 14 is a diagram illustrating a functional structure of the information processing device 20 according to the first modification. In addition to the structure in FIG. 2, the information processing device 20 according to the first modification further includes an editing module 90. After receiving the synthesis operation from the manager and before determining whether the synthesis is possible, the editing module 90 receives editing of the correlation of one or more parameters from the manager.

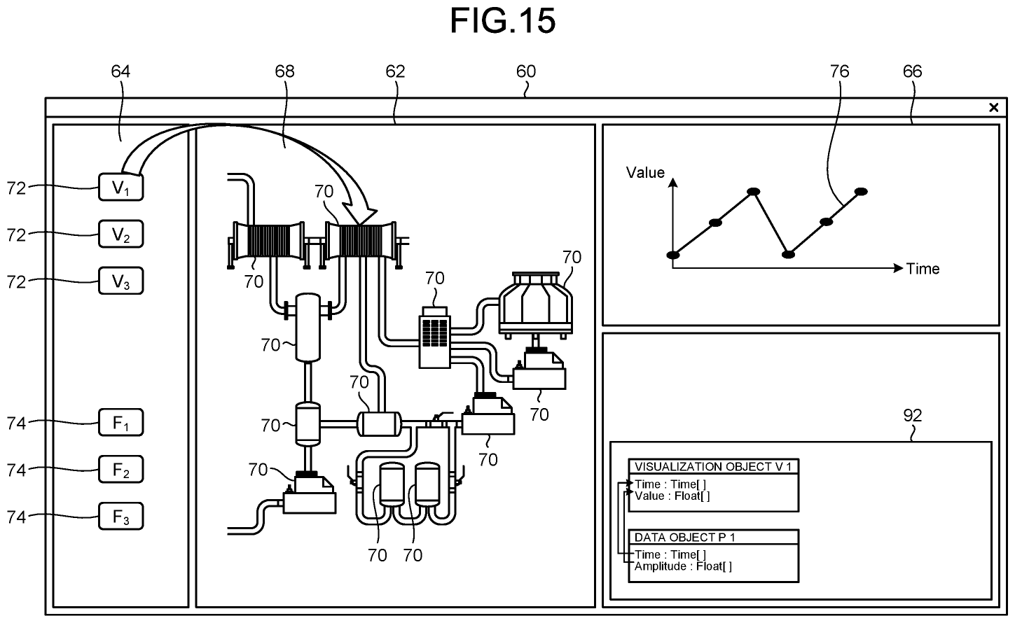

FIG. 15 is a diagram illustrating a first example of the display image 60 of the information processing device 20 according to the first modification. For example, when the data-visualization synthesis operation is performed, the editing module 90 receives, from the manager, the editing of the correlation between each of one or more parameters of the data included in the data group for which the target visualization object can generate image data and each of one or more parameters of the status data included in the status data group held by the target data object.

For example, the display control module 52 causes the editing module 90 to display the display image 60 including an editing region 92. The editing module 90 displays in the editing region 92, an image for correlating one or more parameters of the data included in the data group for which the target visualization object can generate image data with one or more parameters of the status data included in the status data group held by the target data object.

Then, the editing module 90 receives the operation of correlating each of one or more parameters of the data included in the data group for which the target visualization object can generate image data with any of one or more parameters of the status data included in the status data group held by the target data object.

The determination module 54 of the object synthesis module 46 determines, based on the correlation after editing, whether the number of one or more parameters and the data type of each of the one or more parameters of the data included in the data group for which the target visualization object can generate image data correspond to the number of one or more parameters and the data type of each of the one or more parameters of the status data included in the status data group held by the target data object. For example, the determination module 54 performs a determination process to determine whether all the data types correspond to each other among the parameters that are correlated between the target visualization object and the target data object. The generation module 56 of the object synthesis module 46 generates the synthesis object that synthesizes the target data object and the target visualization object on the basis of the correlation after editing.

Thus, when the data-visualization synthesis operation is performed, the information processing device 20 can generate the synthesis object by correlating the parameters on the basis of the operation by the manager.

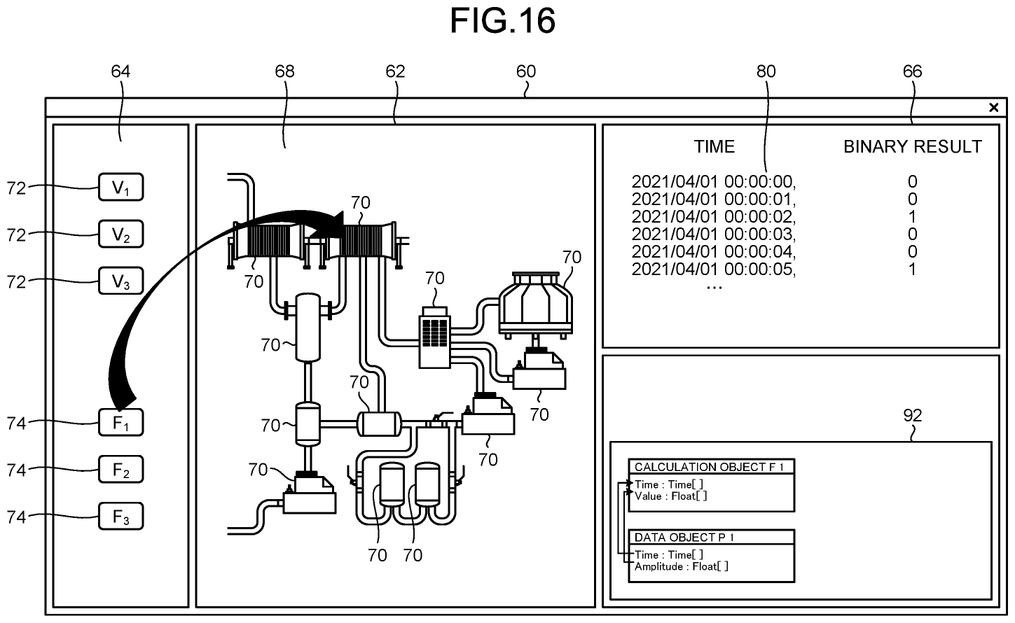

FIG. 16 is a diagram illustrating a second example of the display image 60 of the information processing device 20 according to the first modification. For example, when the data-calculation synthesis operation is performed, the editing module 90 receives, from the manager, editing of the correlation between each of one or more parameters of the data included in the data group that can be calculated by the target calculation object and each of one or more parameters of the status data included in the status data group held by the target data object.

For example, the editing module 90 displays in the editing region 92, the image for correlating one or more parameters of the data included in the data group that can be calculated by the target calculation object with one or more parameters of the status data included in the status data group held by the target data object. Then, the editing module 90 receives the operation of correlating each of one or more parameters of the data included in the data group that can be calculated by the target calculation object with any of one or more parameters of the status data included in the status data group held by the target data object.

The determination module 54 of the object synthesis module 46 determines, based on the correlation after editing, whether the number of one or more parameters and the data type of each of the one or more parameters of the data included in the data group that can be calculated by the target calculation object correspond to the number of one or more parameters and the data type of each of the one or more parameters of the status data included in the status data group held by the target data object. For example, the determination module 54 performs the determination process to determine whether all the data types correspond to each other among the parameters that are correlated between the target calculation object and the target data object. The generation module 56 of the object synthesis module 46 generates the synthesis object that synthesizes the target data object and the target calculation object on the basis of the correlation after editing.

Thus, when the data-calculation synthesis operation is performed, the information processing device 20 can generate the synthesis object by correlating the parameters on the basis of the operation by the manager.

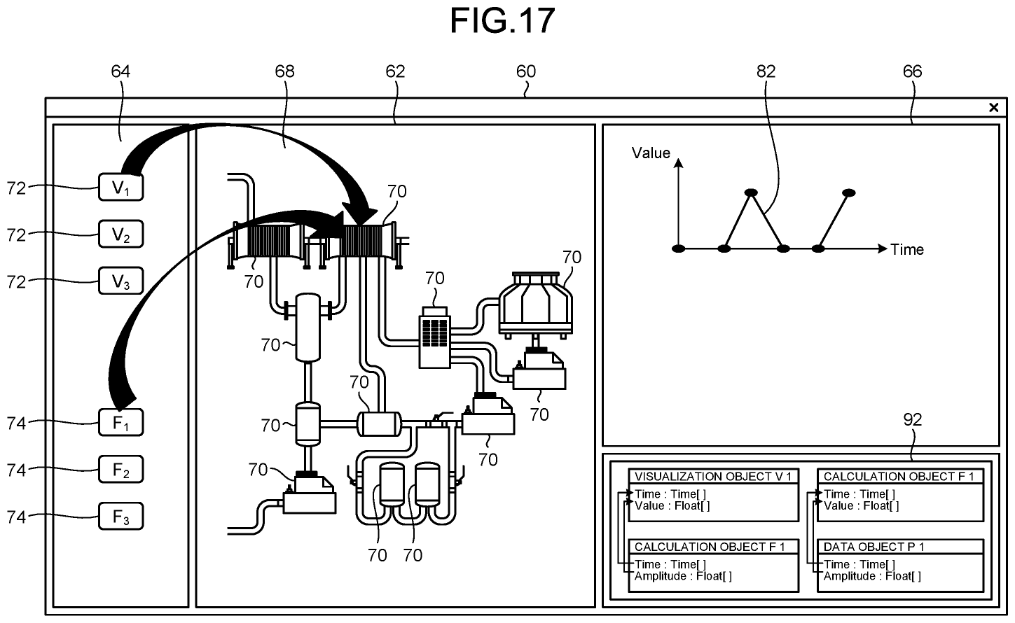

FIG. 17 is a diagram illustrating a third example of the display image 60 of the information processing device 20 according to the first modification. For example, when the data-calculation-visualization synthesis operation is performed, the editing module 90 receives, from the manager, editing of the correlation between each of one or more parameters of the data included in the data group that can be calculated by the target calculation object and each of one or more parameters of the status data included in the status data group held by the target data object. Along with this, the editing module 90 receives, from the manager, the editing of the correlation between each of one or more parameters of the data included in the data group for which the target visualization object can generate image data and each of one or more parameters of the status data included in the result data group obtained by performing the calculation process of the target calculation object.

For example, the editing module 90 displays in the editing region 92, the image for correlating one or more parameters of the data included in the data group that can be calculated by the target calculation object with one or more parameters of the status data included in the status data group held by the target data object. Furthermore, the editing module 90 displays in the editing region 92, the image for correlating one or more parameters of the data included in the data group for which the target visualization object can generate image data with one or more parameters of the status data included in the result data group obtained by performing the calculation process of the target calculation object.

Then, the editing module 90 receives the operation of correlating each of one or more parameters of the data included in the data group that can be calculated by the target calculation object with any of one or more parameters of the status data included in the status data group held by the target data object. Furthermore, the editing module 90 receives the operation of correlating each of one or more parameters of the data included in the data group for which the target visualization object can generate image data with any of one or more parameters of the status data included in the status data group obtained by performing the calculation process of the target calculation object.

The determination module 54 of the object synthesis module 46 determines, based on the correlation after editing, whether the number of one or more parameters and the data type of each of the one or more parameters of the data included in the data group that can be calculated by the target calculation object correspond to the number of one or more parameters and the data type of each of the one or more parameters of the status data included in the status data group held by the target data object. Furthermore, based on the correlation after the editing, the determination module 54 determines whether the number of one or more parameters and the data type of each of the one or more parameters of the data included in the data group for which the target visualization object can generate image data correspond to the number of one or more parameters and the data type of each of the one or more parameters of the result data group obtained by performing the calculation process of the target calculation object.

For example, the determination module 54 performs the determination process to determine whether all the data types correspond to each other among the parameters that are correlated between the target calculation object and the target data object and whether all the data types correspond to each other among the parameters that are correlated between the target visualization object and the target calculation object. Then, the generation module 56 of the object synthesis module 46 generates the synthesis object that synthesizes the target data object, the target calculation object, and the target visualization object on the basis of the correlation after editing.

Thus, when the data-calculation-visualization synthesis operation is performed, the information processing device 20 can generate the synthesis object by correlating the parameters on the basis of the operation by the manager.

Second Modification

Next, the information processing device 20 according to a second modification is described.

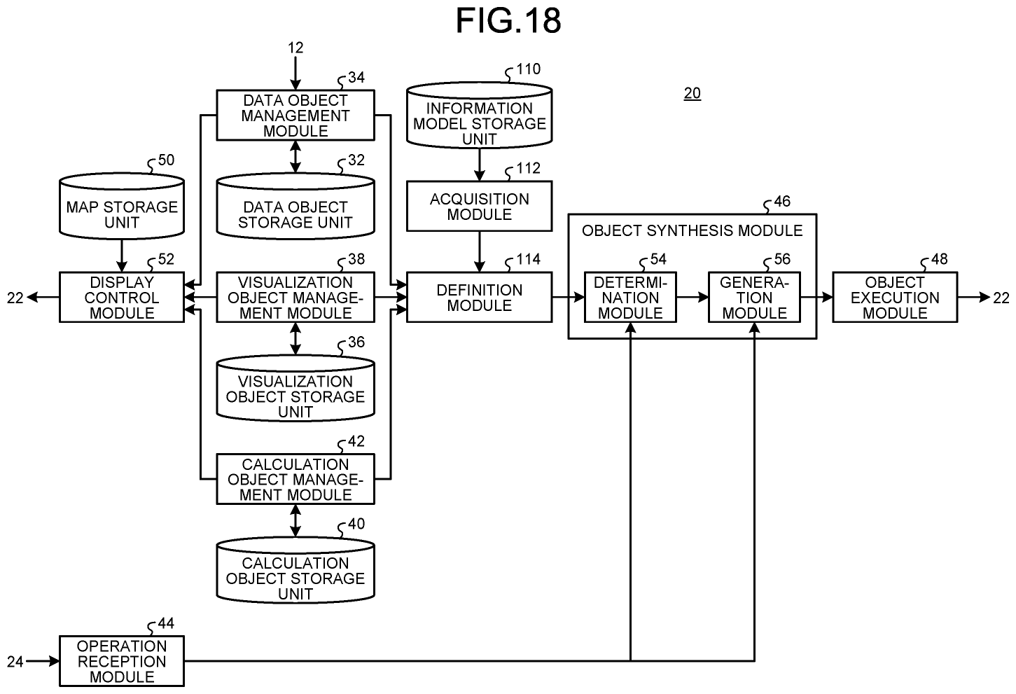

FIG. 18 is a diagram illustrating a functional structure of the information processing device 20 according to the second modification.

The information processing device 20 according to the second modification further includes an information model storage unit 110, an acquisition module 112, and a definition module 114.

For each of the data objects, the information model storage unit 110 stores an information model therein. In the information model, the name and data type acquired from the corresponding facility 12 and the standardized name and standardized data type for each of one or more parameters of the status data included in the status data group are correlated with each other. The facilities 12 in the plant system 10 are manufactured by different manufacturers at different times. Therefore, the name and data type set for the parameter of the status data output from each of the facilities 12 may have different text despite having the same contents. The information model storage unit 110 stores therein the standardized name and data type for each of the one or more parameters of the status data, so that the same standardized name and data type can be set for the parameters with the same contents. The information model is generated by the designer of the plant system 10, for example. When a new facility 12 is added to the plant system 10, the designer stores the information model about the data object corresponding to the new facility 12 in the information model storage unit 110.

When the synthesis operation is performed, the acquisition module 112 refers to the information model to acquire the standardized name of each of one or more parameters of the status data included in the status data group held by the target data object.

When the data-visualization synthesis operation is performed, the definition module 114 compares the name of each of one or more parameters of the data included in the data group for which the target visualization object can generate image data and the standardized name of each of one or more parameters of the status data included in the status data group held by the target data object. Then, the definition module 114 defines the correlation between each of one or more parameters of the data included in the data group for which the target visualization object can generate image data and each of one or more parameters of the status data included in the status data group held by the target data object so that the parameters with the same name are correlated with each other.

When the data-calculation synthesis operation is performed, the definition module 114 compares the name of each of one or more parameters of the data included in the data group that can be calculated by the target calculation object and the standardized name of each of one or more parameters of the status data included in the status data group held by the target data object. Then, the definition module 114 automatically defines the correlation between each of one or more parameters of the data included in the data group that can be calculated by the target calculation object and each of one or more parameters of the status data included in the status data group held by the target data object so that parameters with the same name are correlated with each other. The definition module 114 also performs the similar process when the data-calculation-visualization synthesis operation is performed.

When the data-visualization synthesis operation is performed, the object synthesis module 46 generates the synthesis object on the basis of the correlation after the definition on condition that the number of one or more parameters and the data type of each of the one or more parameters of the data included in the data group for which the target visualization object can generate image data correspond to the number of one or more parameters and the data type of each of the one or more parameters of the status data included in the status data group held by the target data object.

When the data-calculation synthesis operation is performed, the object synthesis module 46 generates the synthesis object on the basis of the correlation after the definition on condition that the number of one or more parameters and the data type of each of the one or more parameters of the data included in the data group that can be calculated by the target calculation object correspond to the number of one or more parameters and the data type of each of the one or more parameters of the status data included in the status data group held by the target data object. The object synthesis module 46 also performs the similar process when the data-calculation-visualization synthesis operation is performed.

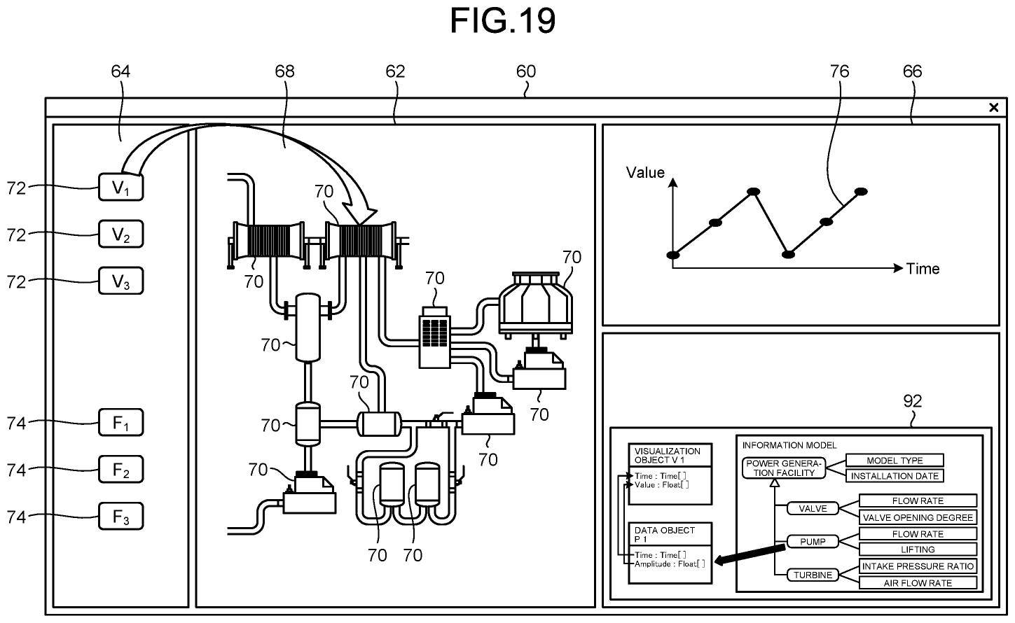

FIG. 19 is a diagram illustrating a first example of the display image 60 of the information processing device 20 according to the second modification. For example, when the data-visualization synthesis operation is performed, the definition module 114 may display the result of defining the correlation in the editing region 92. The definition module 114 may also display the contents of the information model in the editing region 92.

Furthermore, the definition module 114 may receive the editing operation by the manager in a manner similar to the editing module 90 in the first modification. This allows the definition module 114 to correct the correlation if the automatically defined correlation is wrong.

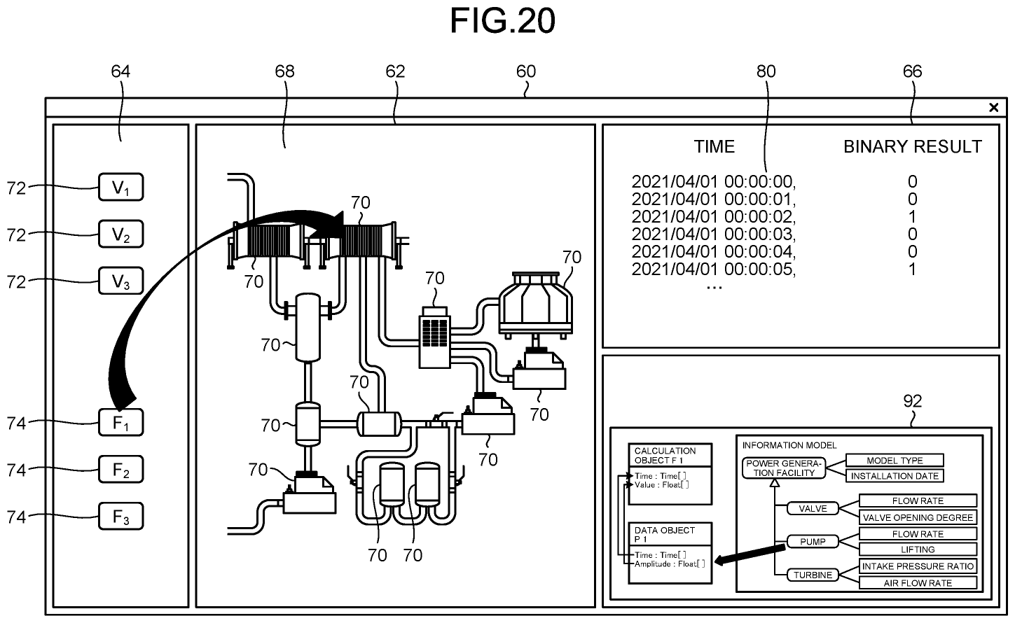

FIG. 20 is a diagram illustrating a second example of the display image 60 of the information processing device 20 according to the second modification. For example, the definition module 114 may display the result of defining the correlation in the editing region 92 when the data-calculation synthesis operation is performed. The definition module 114 may also display the definition result as illustrated in FIG. 20 when the data-calculation-visualization synthesis operation is performed.

In FIG. 20, the definition module 114 may also display the contents of the information model in the editing region 92 or receive the editing operation by the manager in a manner similar to the first modification.

Hardware Structure

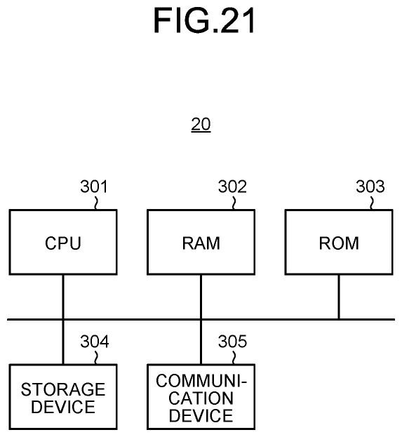

FIG. 21 is a diagram illustrating an example of a hardware structure of the information processing device 20. The information processing device 20 is achieved by a computer with the hardware structure as illustrated in FIG. 21, for example. The information processing device 20 includes a central processing unit (CPU) 301, a random access memory (RAM) 302, a read only memory (ROM) 303, a storage device 304, and a communication device 305. These units are connected through a bus.

The CPU 301 is a processor that executes calculation processes, control processes, and the like according to computer programs. The CPU 301 executes various processes in cooperation with computer programs stored in the ROM 303, the storage device 304, and the like using a predetermined area of the RAM 302 as a work area.

The RAM 302 is a memory such as a synchronous dynamic random access memory (SDRAM). The RAM 302 serves as the work area for the CPU 301. The ROM 303 is a non-rewritable memory that stores computer programs and various kinds of information.

The storage device 304 is a device that writes and reads data in a semiconductor storage medium such as flash memory, a magnetically or optically recordable storage medium, or the like. The storage device 304 writes and reads data to and from a storage medium in accordance with the control from the CPU 301. The communication device 305 communicates with external devices via a network in accordance with the control from the CPU 301.

The computer program to be executed in the computer has a module structure including a data object management module, a visualization object management module, a calculation object management module, an operation reception module, an object synthesis module, an object execution module, and a display control module. In addition, the computer program may further include an editing module, an acquiring module, and a defining module.

This computer program is developed and executed on the RAM 302 by the CPU 301 (processor) to cause the computer to function as the data object management module 34, the visualization object management module 38, the calculation object management module 42, the operation reception module 44, the object synthesis module 46, the object execution module 48, and the display control module 52. The computer program may further make the editing module 90, the acquisition module 112, and the definition module 114 function. The RAM 302 and the storage device 304 function as the data object storage unit 32, the visualization object storage unit 36, the calculation object storage unit 40, and the map storage unit 50. The RAM 302 and the storage device 304 may further function as the information model storage unit 110.

The computer program to be executed in a computer is provided by being recorded in a computer-readable recording medium such as a CD-ROM, a flexible disk, a CD-R, or a digital versatile disc (DVD) in a format that can be installed on a computer or as a file in an executable format.

This computer program may be provided by being stored on a computer connected to a network such as the Internet and downloaded through the network. The computer program may alternatively be provided or distributed through a network such as the Internet. The computer program to be executed in the information processing device 20 may be provided by being incorporated in advance in the ROM 303 or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and
one or more processors coupled to the memory and configured to:
generate, in a case where a first synthesis operation of synthesizing one target data object among a plurality of data objects that hold a status data group representing a status of a facility and one target visualization object among a plurality of visualization objects that generate image data representing a data group is performed, on condition that an attribute of one or more parameters in the data group for which the target visualization object is able to generate the image data corresponds to an attribute of one or more parameters in the status data group held by the target data object, the image data representing the status data group held by the target data object in a display format defined in the target visualization object; and
cause a display device to display the image data.

2. The device according to claim 1, wherein
each of the data objects is correlated with one of a plurality of the facilities and holds a status data group representing a status of the corresponding facility, and
each of the visualization objects generates image data representing a data group in a display format defined in advance.

3. The device according to claim 2, further comprising:
the one or more processors are configured to:
receive the first synthesis operation;
generate a synthesis object, in the case where the first synthesis operation is performed, on condition that an attribute of one or more parameters in the data group for which the target visualization object is able to generate the image data corresponds to an attribute of one or more parameters in the status data group held by the target data object; and
execute the synthesis object, and
the synthesis object holds the status data group held by the target data object, generates the image data representing the status data group in the display format defined in the target visualization object, and causes the display device to display the image data.

4. The device according to claim 3, wherein
the one or more processors are configured to:
receive a second synthesis operation of synthesizing the target data object, one target calculation object among a plurality of calculation objects performing a calculation process on the data group to calculate a result data group, and the target visualization object; and
generate the synthesis object in a case where the second synthesis operation is performed, on condition that the attribute of one or more parameters in the data group that is able to be calculated by the target calculation object corresponds to the attribute of one or more parameters in the status data group held by the target data object, and that the attribute of one or more parameters in the data group for which the target visualization object is able to generate the image data corresponds to the attribute of one or more parameters in the result data group obtained by performing the calculation process of the target calculation object, and
the synthesis object holds the status data group held by the target data object, performs the calculation process defined in the target calculation object on the status data group to calculate the result data group, and generates the image data representing the result data group in the display format defined in the target visualization object to cause the display device to display the image data.

5. The device according to claim 4, wherein each of the calculation objects performs the calculation process defined in advance on the data group to calculate the result data group.

6. The device according to claim 3, wherein
the one or more processors are configured to:
cause the display device to display a plurality of visualization object icons corresponding to the visualization objects, and a plurality of data object icons corresponding to the data objects; and
receive the first synthesis operation, in a case where an operation of correlating a data object icon among the data object icons and a visualization object icon among the visualization object icons is performed, while a data object corresponding to the data object icon for which the correlating operation is performed is set as the target data object and a visualization object corresponding to the visualization object icon for which the correlating operation is performed is set as the target visualization object.

7. The device according to claim 4, wherein
the one or more processors are configured to:
cause the display device to display a plurality of visualization object icons corresponding to the visualization objects, a plurality of data object icons corresponding to the data objects, and a plurality of calculation object icons corresponding to the calculation objects; and
receive the second synthesis operation, in a case where an operation of correlating a data object icon among the data object icons, a calculation object icon among the calculation object icons, and a visualization object icon among the visualization object icons is performed, while a data object corresponding to the data object icon for which the correlating operation is performed is set as the target data object, a calculation object corresponding to the calculation object icon for which the correlating operation is performed is set as the target calculation object, and a visualization object corresponding to the visualization object icon for which the correlating operation is performed is set as the target visualization object.

8. The device according to claim 6, wherein the one or more processors are configured to cause the display device to display a map image representing arrangement and a connection relation of the facilities, and to display each of the data object icons at a position of the corresponding facility among the facilities on the map image.

9. The device according to claim 3, wherein the one or more processors are configured to generate, in the case where the first synthesis operation is performed, the synthesis object on condition that a number of the one or more parameters and a data type of each of the one or more parameters of data included in the data group for which the target visualization object is able to generate the image data correspond to a number of the one or more parameters and a data type of each of the one or more parameters of status data included in the status data group held by the target data object.

10. The device according to claim 4, wherein the one or more processors are configured to generate, in the case where the second synthesis operation is performed, the synthesis object on condition that a number of the one or more parameters and a data type of each of the one or more parameters of data included in the data group that is able to be calculated by the target calculation object correspond to a number of the one or more parameters and a data type of each of the one or more parameters of status data included in the status data group held by the target data object, and that a number of the one or more parameters and a data type of each of the one or more parameters of data included in the data group for which the target visualization object is able to generate the image data correspond to a number of the one or more parameters and a data type of each of the one or more parameters of data included in the result data group obtained by performing the calculation process of the target calculation object.

11. The device according to claim 9, wherein
the one or more processors are configured to:
receive, in the case where the first synthesis operation is performed, editing of a correlation between each of the one or more parameters of the data included in the data group for which the target visualization object is able to generate the image data and each of the one or more parameters of the status data included in the status data group held by the target data object; and
determine whether the attribute of the one or more parameters in the data group for which the target visualization object is able to generate the image data corresponds to the attribute of the one or more parameters in the status data group held by the target data object, based on the correlation after editing.

12. The device according to claim 10, wherein
the one or more processors are configured to:
receive, in the case where the second synthesis operation is performed, editing of a correlation between each of the one or more parameters of the data included in the data group that is able to be calculated by the target calculation object and each of the one or more parameters of the status data included in the status data group held by the target data object, and editing of a correlation between each of the one or more parameters of the data included in the data group for which the target visualization object is able to generate the image data and each of the one or more parameters of the result data included in the result data group obtained by performing the calculation process of the target data object; and
determine whether the attribute of the one or more parameters in the data group that is able to be calculated by the target calculation object corresponds to the attribute of the one or more parameters in the status data group held by the target data object and whether the attribute of the one or more parameters in the data group for which the target visualization object is able to generate the image data corresponds to the attribute of the one or more parameters in the result data group obtained by performing the calculation process of the target calculation object, based on the correlation after editing.

13. The device according to claim 9, wherein
the memory is configured to store an information model for correlating a name managed in the corresponding facility and a standardized name, for each of the one or more parameters of the status data included in the status data group, for each of the data objects, and
the one or more processors are configured to:
acquire the standardized name for each of the one or more parameters of the status data included in the status data group held by the target data object with reference to the information model;
compare the name of each of the one or more parameters of the data included in the data group for which the target visualization object is able to generate the image data with the standardized name of each of the one or more parameters of the status data included in the status data group held by the target data object, to define a correlation between each of the one or more parameters of the data included in the data group for which the target visualization object is able to generate the image data and each of the one or more parameters of the status data included in the status data group held by the target data object; and
determine whether the attribute of the one or more parameters in the data group for which the target visualization object is able to generate the image data corresponds to the attribute of the one or more parameters in the status data group held by the target data object, based on the correlation after defining.

14. An information processing device comprising:
a memory; and
one or more processors coupled to the memory and configured to:
perform, in a case where a synthesis operation of synthesizing one target data object among a plurality of data objects that hold a status data group representing a status of a facility and one target calculation object among a plurality of calculation objects that perform a calculation process on a data group to calculate a result data group, on condition that an attribute of one or more parameters in the data group that is able to be calculated by the target calculation object corresponds to an attribute of one or more parameters in the status data group held by the target data object, a calculation process defined in the target calculation object on the status data group held by the target data object to calculate the result data group; and
cause a display device to display the calculated result data group.

15. A display method for displaying information, the method comprising:
generating, by an information processing device, in a case where a first synthesis operation of synthesizing one target data object among a plurality of data objects that hold a status data group representing a status of a facility and one target visualization object among a plurality of visualization objects that generate image data representing a data group is performed, on condition that an attribute of one or more parameters in the data group for which the target visualization object is able to generate the image data corresponds to an attribute of one or more parameters in the status data group held by the target data object, the image data representing the status data group held by the target data object in a display format defined in the target visualization object; and
causing a display device to display the image data.

16. A computer program product comprising a computer-readable medium including programmed instructions, the instructions causing a computer to execute:
generating, in a case where a first synthesis operation of synthesizing one target data object among a plurality of data objects that hold a status data group representing a status of a facility and one target visualization object among a plurality of visualization objects that generate image data representing a data group is performed, on condition that an attribute of one or more parameters in the data group for which the target visualization object is able to generate the image data corresponds to an attribute of one or more parameters in the status data group held by the target data object, the image data representing the status data group held by the target data object in a display format defined in the target visualization object; and
causing a display device to display the image data.
